(19) United States
(12) Patent Application Publication
(10) Pub. No.: US 2014/0067532 A1
(43) Pub. Date: Mar. 6, 2014

(54) USE OF PERSONAL PREFERENCES TO CONTROL PRESENTATION OF ADVERTISEMENTS

(71) Applicants: Don Nelson, Randolph, NJ (US); Adam Roozen, Minneapolis, MN (US)

(72) Inventors: Don Nelson, Randolph, NJ (US); Adam Roozen, Minneapolis, MN (US)

(21) Appl. No.: 14/018,411

(22) Filed: Sep. 4, 2013

Related U.S. Application Data
(60) Provisional application No. 61/696,679, filed on Sep. 4, 2012.

(51) Int. Cl. G06Q 30/02

(52) U.S. Cl. CPC G06Q 30/0257
USPC 705/14.53

(57) ABSTRACT

This disclosure relates to a software-based system and method for management and display of advertisements based on personal preference information.

### RELATED APPLICATIONS

This application relates to U.S. Patent Application Ser. No. 61/696,679 filed on Sep. 4, 2012, titled USE OF PERSONAL PREFERENCES TO CONTROL PRESENTATION OF ADVERTISEMENTS, which is hereby incorporated by reference in its entirety.

### FIELD OF THE DISCLOSURE

This disclosure relates to a software-based system and method for management and display of advertisements based on personal preference information.

### BACKGROUND

Brands and advertisers communicate to consumers by pushing ads at them in a multitude of ways. Advertising is served to consumers through multiple networks, on various platforms, and experienced through various form factors. Advertising is everywhere the average consumer is: at home, on the road, on the phone, on the Internet, at work—wherever consumers are, advertisers are trying to push their offers and/or value proposition to them, and they are becoming cleverer about how to reach the right target, at the right time with the right message.

Brands and advertising agencies project their messages based on differing degrees of demographic data and, increasingly in the digital space, on behavioral data along with loyalty programs. In some instances, consumers can opt-out of unwanted and noisy advertising through channels like the National Do Not Call Registry or AdChoices.

Unfortunately, these are often difficult to navigate and not easy for the average consumer to understand. Furthermore, simply opting into or out of marketing is not an ideal solution. Advertising is a beneficial activity for both brands and consumers when done correctly. No solution currently exists to allow for advertising to flow to consumers, with consumers having control to choose the advertisements that are relevant to them based on their own personal criteria.

### SUMMARY

Consumer driven, controlled and requested advertising puts the consumer in the driver's seat of the advertising to which they are exposed, across multiple platforms (advertising and content networks) as well as multiple form factors, for example, the Internet, mobile web browsers and applications, and television. Consumers opt in to this service and leverage the technology to receive relevant and personalized advertisements, thereby reducing some of the noise. Advertisers will benefit by leveraging the technology to direct their marketing messages and promotions to consumers who are “asking” for them, versus hoping they “touch” some relevant consumers through mass targeting.

This summary is provided to introduce a selection of concepts. These concepts are further described below in the Detailed Description. This summary is not intended to identify key features or essential features of the claimed subject matter, nor is this summary intended as an aid in determining the scope of the claimed subject matter.

### BRIEF DESCRIPTION OF THE DRAWINGS

FIG. 1 is a block diagram illustrating an example system.

FIG. 2 is a flow chart illustrating an example of where and how users will interact with the consumer front-end of the experience controlling their advertisements in one embodiment of the present invention.

FIG. 3 is a flowchart illustrating an example operation performed by a Consumer Controlled Advertising API in one embodiment of the present invention.

FIGS. 4 and 4a describe an example graphical user interface for the Preference Center in one embodiment of the present invention.

FIG. 5 is a flow chart showing the Meta Data Enrichment process in one embodiment of the present invention.

FIG. 6 is a flow chart illustrating the Consumer Controlled Advertising API interface in one embodiment of the present invention.

FIG. 7 illustrates an example of a user's dashboard on a graphical user interface in one embodiment of the present invention.

FIG. 8 illustrates an example of categories and subcategories available for selection by the user on a graphical user interface in one embodiment of the present invention.

FIG. 9 illustrates an example of a selected category and corresponding advertisement on a graphical user interface in one embodiment of the present invention.

FIG. 10 illustrates an example of a displayed advertisement on a graphical user interface while using a web service in one embodiment of the present invention.

FIG. 11 illustrates a second example of a displayed advertisement on a graphical user interface while using a web service in one embodiment of the present invention.

### DETAILED DESCRIPTION

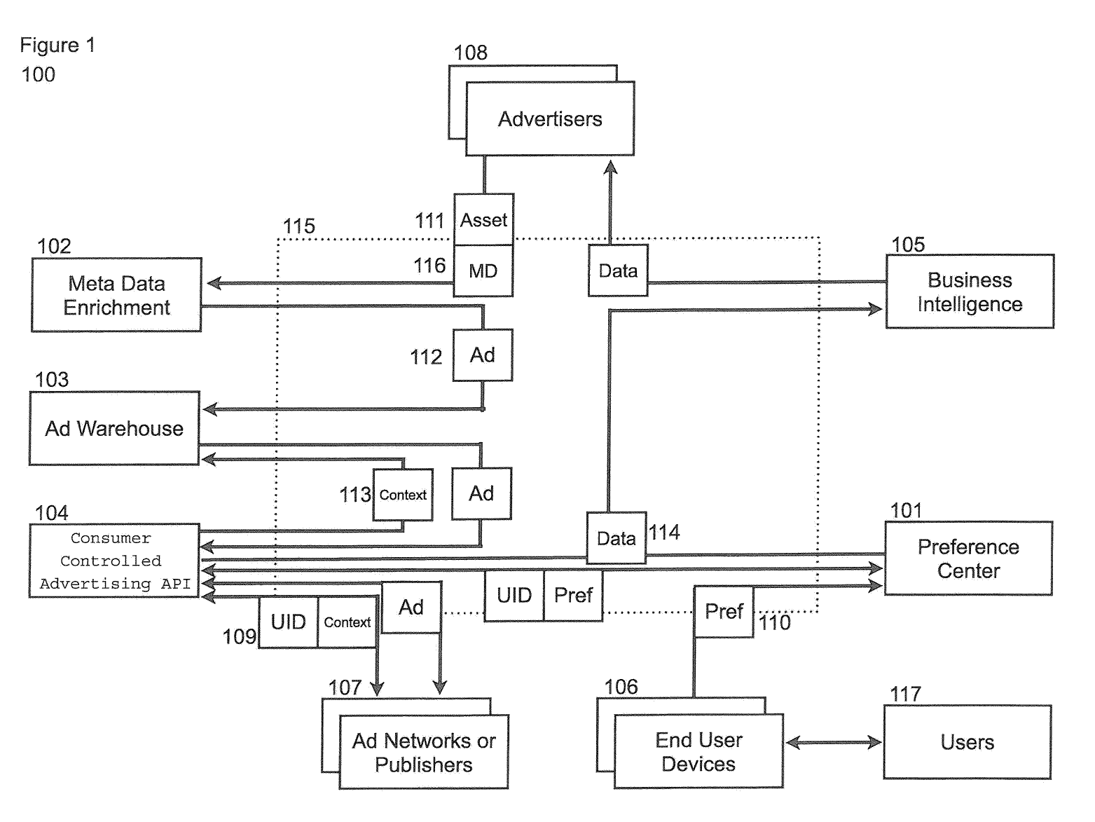

FIG. 1 is a block diagram illustrating an example system 100. As illustrated in the example of FIG. 1, the system 100 comprises a set of a Preference Center 101, Meta Data Enrichment 102, Ad Warehouse 103, Consumer Controlled Advertising API 104, Business Intelligence 105, End User Devices 106, Ad Networks or Publishers 107, Advertisers 108, User ID (UID) 109, User Preferences (Pref) 110, Advertising Assets (Asset) 111, Advertisement (Ad) 112, Publisher Context (Context) 113, Reporting Data (Data) 114, Meta Data (MD) 116, and Network 115. Preference Center 101, Meta Data Enrichment 102, Ad Warehouse 103, Consumer Controlled Advertising API 104, Business Intelligence 105, End User Devices 106, and Ad Networks or Publishers 107 are computing systems.

The Network 115 facilitates communication among the Preference Center 101, Meta Data Enrichment 102, Ad Warehouse 103, Consumer Controlled Advertising API 104, Business Intelligence 105, End User Devices 106, Ad Networks or Publishers 107, and Advertisers 108. In various embodiments, the Network 115 can be various types of networks. For example, the Network 115 can be a wide area network, such as the Internet. In another example, the Network 115 can be a local area network, a virtual private network, or another type of communications network. The Network 115 can include wired and/or wireless communication links.

The Preference Center 101 is a system of computing devices that contains a collection of User Preferences 110 for each user of the system. User Preferences 110 might include, but are not limited to, personal needs, wants, wishes and desires for each content category in the system. Users can create accounts, and submit and modify their User Preferences 110 through a user interface over the Network 115.

The Meta Data Enrichment 102 is a system of computing devices that allows Advertisers 108 to submit combinations of Advertisements 112 and Meta Data 116. Advertisers 108 submit the information through a user interface over the Network 115. The Meta Data Enrichment 102 facilitates the input by detecting key attributes of the Advertisements 112 and repurposing previously entered information to help Advertisers 108 complete the combinations of Advertisements 112 and Meta Data 116.

The Ad Warehouse 103 is a system of computing devices that stores combinations of Advertisements 112 and Meta Data 116 as Advertisements 112.

The Consumer Controlled Advertising API 104 is a system of computing devices that determines which Advertisements 112 should be presented to a User ID 109, considering User Preferences 110 and Publisher Context 113.

The Business Intelligence 105 is a system of computing devices that collects and organizes Reporting Data 114 and presents it to Advertisers 108 for decision-making purposes.

As illustrated in the example of FIG. 1, the system 100 also comprises a set of Users 117. The Users 117 use the End User Devices 106 to access the Preference Center 101. The End User Devices 106 can be a variety of different types of computing devices. For example, the End User Devices 106 can be desktop computers, workstation computers, video game consoles, television set top boxes, network-connected televisions, or other types of computing devices. Furthermore, the End User Devices 106 can be mobile computing devices, such as smart phones (e.g., Apple iPhones, Motorola Droid phones), tablet computers (e.g., Apple iPads), personal media players (e.g., Apple iPods, Microsoft Zune players), in-vehicle computing systems, laptop computers, netbooks, or any other mobile computing devices.

The Ad Networks or Publishers 107 is a system of computing devices that publish Advertisements 112 to Users 117 on various properties, both online and offline. Ad Networks can include but are not limited to demand and supply side platforms, ad exchanges, data providers, agency trading desks, ad servers, DMP's, aggregators, etc.; Publishers 107 can include, but are not limited to, content destinations and networks like CNN, CNN.com, AOL, NBC, Time Warner, Verizon, Yahoo, Comcast, PRN, The Weather Channel, etc.; commerce publishers like Walmart.com, Amazon, eBay, Home Depot, Groupon, etc.; and social networks like Facebook, LinkedIn, Twitter, FourSquare, etc.

The Advertisers 108 are users that create Advertisements 112 that are intended to be published to Users 117. Advertisers 108 can include brands and their respective agencies. Examples include Ford Motor Company, American Express, United Airlines, Proctor and Gamble brands, Sara Lee Corp, Wal-Mart, Macy's, Costco, Dell, Coca Cola, and Bank of America, among others.

Users 117 interact with the Preference Center 101 by submitting and modifying User Preferences 110. The User Preferences 110 could include various products or services the User 117 needs, wants, wishes, and/or desires. Furthermore, User Preferences 110 could include, among other things, other settings including calendar planning and timing, price ranges, discount ranges, geographic locations, brand and category affinities and dislikes, communications preferences, tracking options, etc. Products and services are those offered by Advertisers 108 through their respective line of business.

Depending on user choice during interaction with the Preference Center 101, users' specificity and sensitivity to the choices is known and can be utilized to present the user with ads. For example, if user says Want=Sedan and Brand=Toyota, Honda, Infinity . . . etc., the user is more specific about the Model he/she wants to buy and not so sensitive to the brand itself. This can also be used to determine or develop brand analytics and present the brands with data/report on how end users are loyal to the brands as a score.

For examples, when someone chooses BMW but they do not choose others, that implies high loyalty. But, when someone chooses Infiniti, and they also choose Toyota, Honda and Chevrolet, their loyalty factor is low. With information like this, the system can filter the advertisements to reflect, among other things, user preference, viewing context (time, place, etc . . . ) and viewability on a particular User device.

Further, by extracting attributes of “customers have's in past,” a customers liking to certain attributes can be determined by various algorithms, one of which can be an overlap of a set containing attributes of items (choices, options), which user “had” or made in the past.

Advertisers 108 currently create Advertisements 112 and route them to Ad Networks or Publishers 107 to be published to Users 117. Ad Networks or Publishers 107 typically choose which Advertisements 112 to publish to a User 117 based on previous behavior of the User 117 and/or Publisher Context 113. Publisher Context 113 typically includes keywords on the publisher property.

In System 100, Advertisers 108 will route Advertisements 112 to Meta Data Enrichment 102. They will also add Meta Data 116 for each of the Advertisements 112. Meta Data Enrichment 102 will also facilitate the addition of Meta Data 116 in various ways, including keywords and attachment phrases describing the content and purpose of the advertisement. Meta Data 116 includes, but is not limited to, related data sets, creative copy, available detailed product or service descriptions, offer period and description, embedded contextual content, etc. The Meta Data could be as simple as a cloud of tags or richer key/value pairs indicating users' psychological needs and wants.

Meta Data Enrichment 102 submits the Advertisements 112 to the Ad Warehouse 103 to be stored, and to be referenced by the Consumer Controlled Advertising API 104. Advertisements 112 are stored in a structured format, so that User Preferences 110 and Publisher Context 113 can be used as search parameters to find relevant Advertisements 112 in the Ad Warehouse 103 by the Consumer Controlled Advertising API 104.

Ad Networks or Publishers 107 submit a request to Consumer Controlled Advertising API 104 each time a User 117 visits their property. If the User 117 is anonymous and cannot be identified, the request contains Publisher Context 113. If the User 117 can be identified, the request contains Publisher Context 113 and User ID 109.

The Consumer Controlled Advertising API 104 uses the Publisher Context 113 and, if available, the User ID 109, and references the Preference Center 101 and the Ad Warehouse 103 to identify the best Advertisements 112 to be published. The Consumer Controlled Advertising API 104 considers several factors when providing a recommendation back to the Ad Networks or Publishers 107, including but not limited to Publisher Context 113 and User Preferences 110.

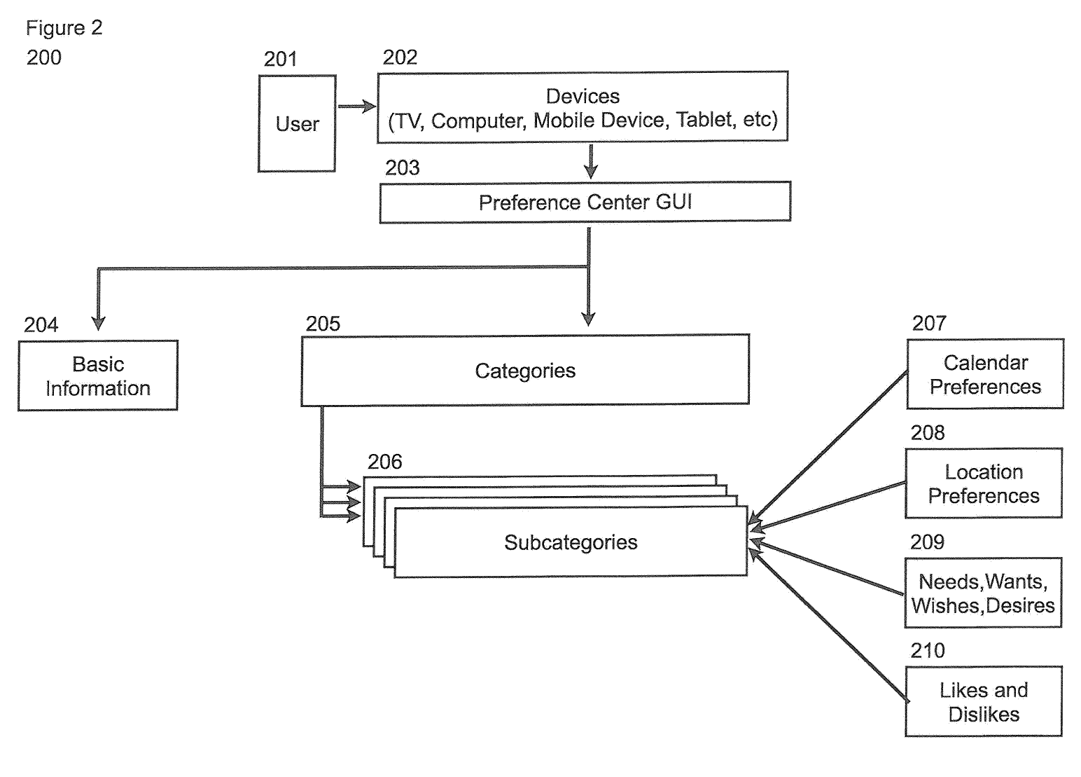

FIG. 2 is a flow chart illustrating where and how users 201 will interact with the consumer front-end of the experience controlling their advertisements 200, including but not limited to a preference center interface 203 viewed through web sites, Digital TV apps, mobile and tablet applications, personal computer and web-based applications 202. As Users share timely and relevant information about themselves 204, their purchase behaviors, and their product and service needs, wants, desires and wishes 209, as well as likes and dislikes 210, they will be directed through a psychological, intuitive experience to assist in selecting categories 205 and subcategories 206 and brands of interest to them and enable timeliness by including personal calendar planning 207 and location relevance by including location preference information 208. A user ID is then issued for matching as illustrated in FIG. 1.

One incarnation of a matching algorithm captures a subset match on cloud of tags. Another incarnation of a matching algorithm treats key value pairs like rules for specifying matching criteria. Further, another incarnation of the matching process can utilize the feedback of individuals on the ad to prioritize the ad content

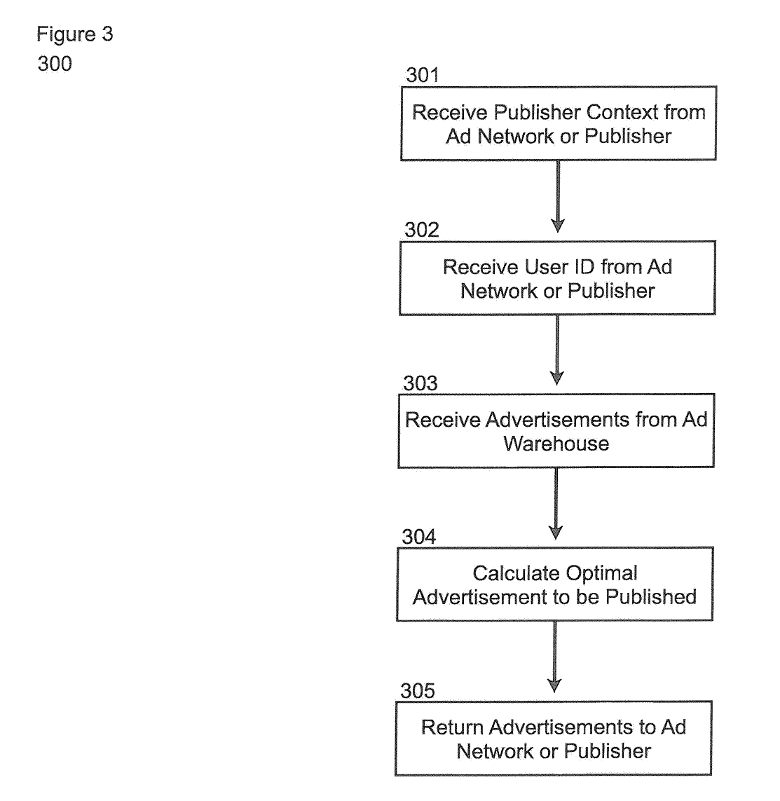

FIG. 3 is a flowchart illustrating an example operation 300 performed by Consumer Controlled Advertising API 104. As illustrated in the example of FIG. 3, the operation 300 begins when the Ad Network or Publisher 107 submits a query 301 to Consumer Controlled Advertising API 104 containing Publisher Context 113 and User ID 109, if available, 302. The system then retrieves advertisements from the Ad Warehouse 303, calculates an optimal advertisement to be published 304 and then returns advertisements to the Ad Network or Publisher 305.

As discussed above, Publisher Context 113 describes the property that the Advertisement 112 will be displayed on. For example, the Publisher Context 113 can include audience data, registered shopper/visitor data, opt-in badge, button or widget, brand content and attributes, etc. In this example, the Consumer Controlled Advertising API 104 uses the Publisher Context 113 and the User ID 109 to find relevant Advertisements 112 that contain Meta Data 116 in the Ad Warehouse 103 that match the Publisher Context 113 and User ID 109.

In other embodiments, either the Publisher Context 113 or the User ID 109 is not available. In these cases, the Consumer Controlled Advertising API 104 uses any information that is submitted to find relevant Advertisements 112 in the Ad Warehouse 103.

To find relevant Advertisements 112 in the Ad Warehouse 103 based on Publisher Context 113 and User ID 109, the Consumer Controlled Advertising API 104 will scroll and then match indexed data attributes associated with both consumer preferences and identifiers; and advertisement data attributes and identifiers through real-time, learning algorithmic function and integration.

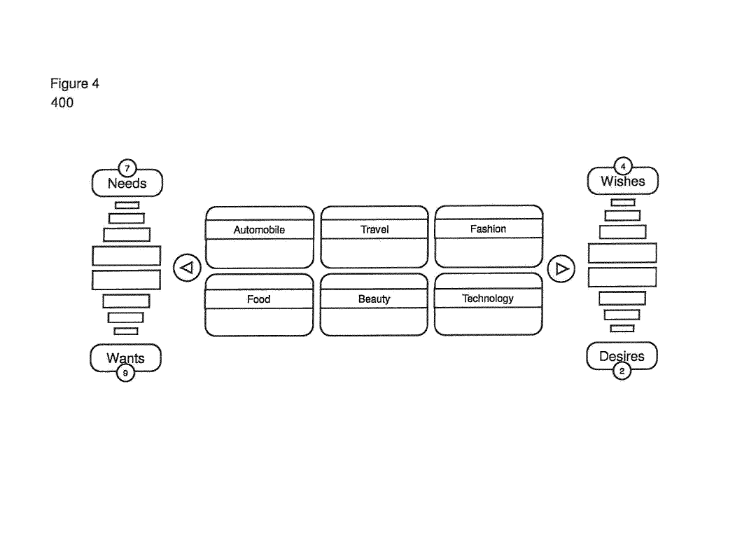

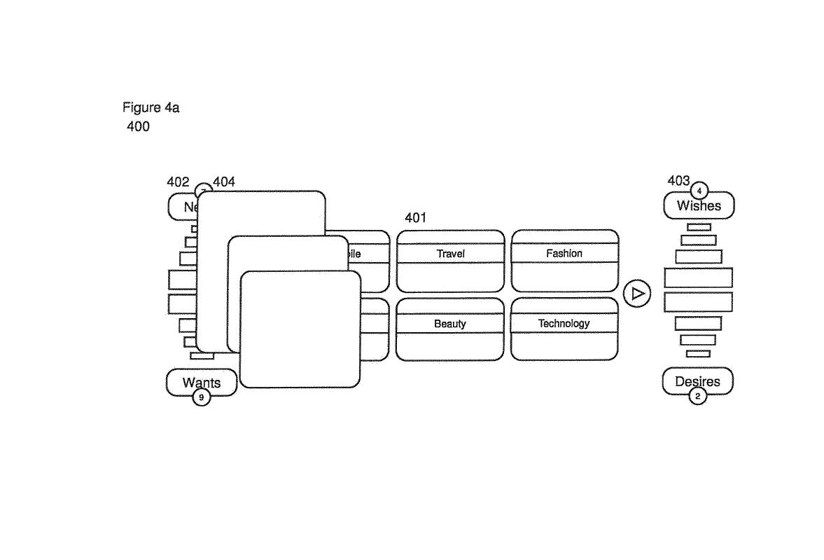

FIGS. 4 and 4a describe an example graphical user interface, or GUI 400, for the Preference Center 101. In this example, the user is presented with their existing preferred categories 401. The user can interact with any one of the Needs, Wants, Wishes, or Desires buttons 402, 403 to configure their preferences for that particular preference type. For example, if the user clicks Needs 402, then the category tree 404 appears. The user then selects or de-selects categories, which adds or removes them from their “Needs” preferences. Additionally, more settings may be available for the user when choosing a category in this context, including location or time.

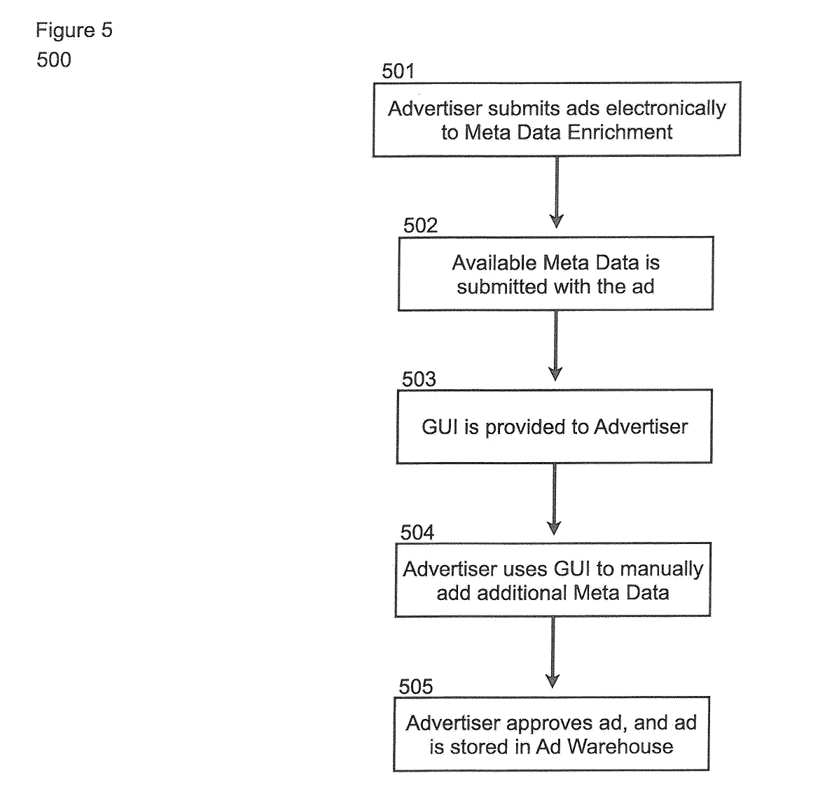

FIG. 5 shows the Meta Data Enrichment 102 process. This process 500 is used to attach Meta Data 116 to an Asset 111 (such as an ad). This Meta Data is later evaluated and used by the system to provide recommendations to Ad Networks and Publishers 107. When an Asset 111 is submitted to Meta Data Enrichment 102 by an Advertiser 108, 501, the Advertiser 108 can include Meta Data 116 with the Asset 111 in the electronic submission 502. Additionally, the Advertiser 108 will gain access to a GUI that allows them to see what Meta Data 116 has been added 503, and add additional Meta Data 116 manually to the Asset 111, 504. Finally, the Advertiser 108 can approve the Asset 111 with its associated Meta Data 116. Once approved 505, the data is moved into the Ad Warehouse 103.

In furtherance of the foregoing, the system could use machine learning to add meta data. For example, the process could use image recognition technology to infer attributes of the image (e.g., color, text, shapes, of an ad) and map these image attributes to human produced Meta Data. Over a large number of samples, this could reinforce the mapping of attributes to automatically infer human produced meta data. Modifying the meta-data enrichment process by vetting automatically-generated Meta Data instead of tagging could speed up the Meta Data Enrichment Process.

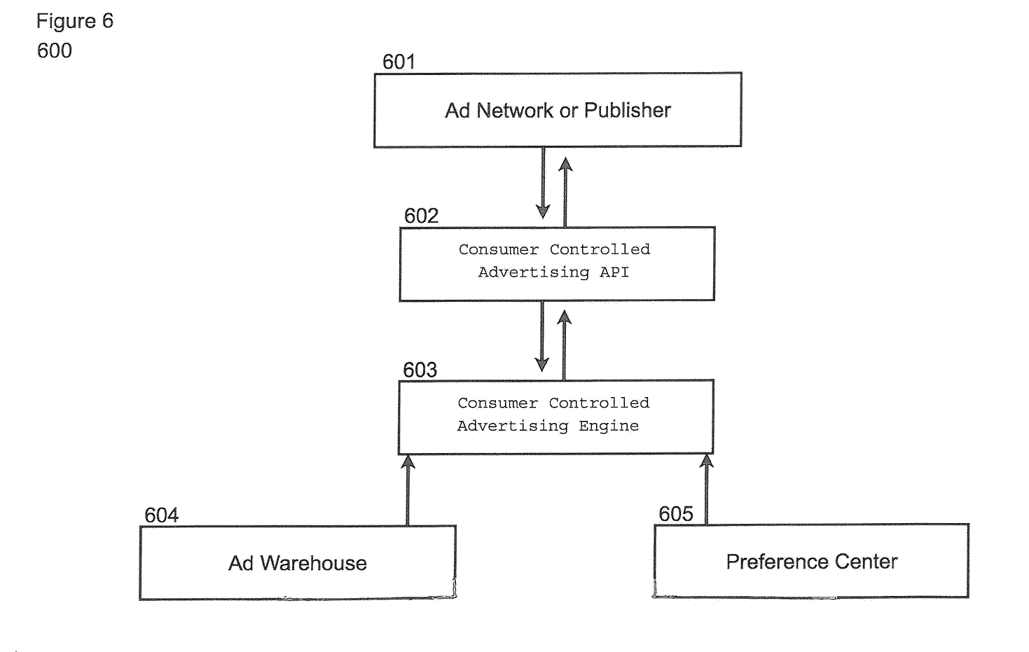

FIG. 6 depicts a sample process 600 by which an ad would be selected to display to a particular user. In this example, the Ad Network or Publisher 601 makes a system call to Consumer Controlled Advertising API 602. The call will contain Publisher Context 113 including, but not limited to, User ID, Publisher ID, and keywords that describe the context of the property that the ad will be placed within. The Consumer Controlled Advertising API 602 passes the information to the Consumer Controlled Advertising Engine 603. The Consumer Controlled Advertising Engine 603 matches user preferences with the appropriate ads in the Ad Warehouse 604. The Consumer Controlled Advertising Engine 603 imports Preferences 110 from the Preference Center 605 that match the User ID. The Consumer Controlled Advertising Engine 603 imports Ads from the Ad Warehouse 604 that contain Meta Data 116 that matches the Preferences 110 and the Publisher Context 113. The Consumer Controlled Advertising Engine 603 then processes the data to determine which ad is to be returned back to the Ad Network or Publisher 601.

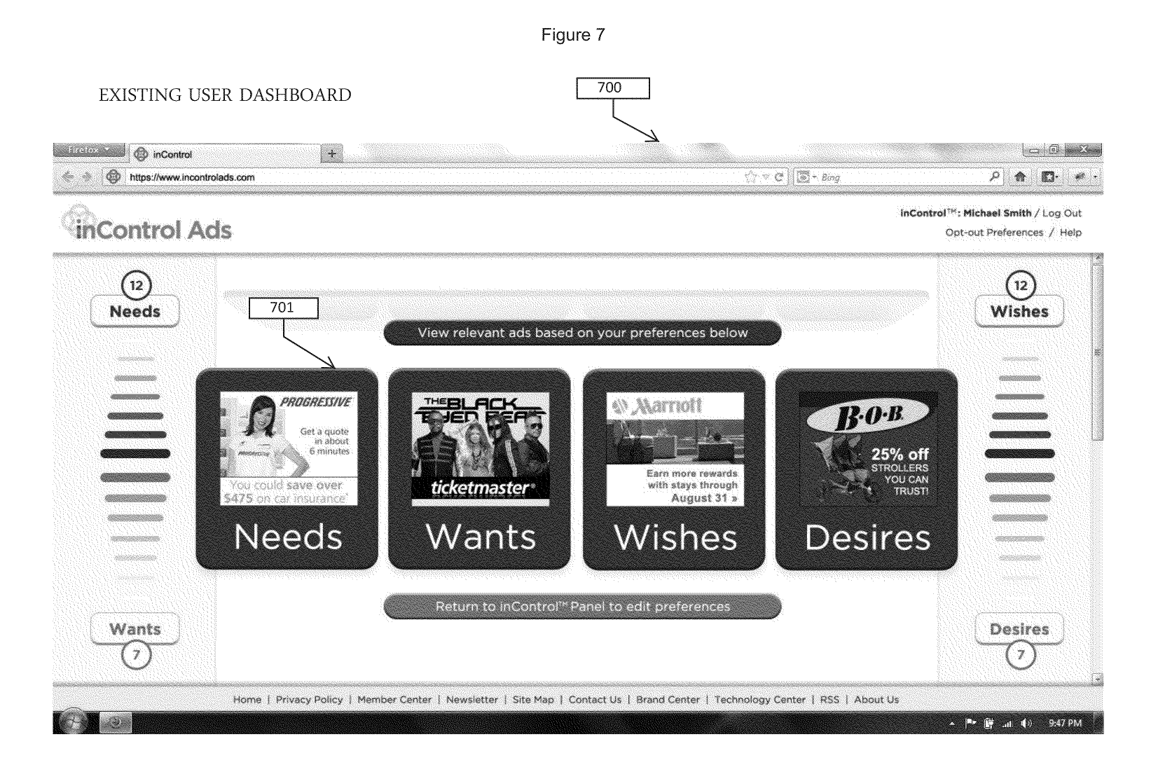

FIGS. 7 through 11 illustrate select portions of a possible digital and web user experience to illustrate an example of the interface and user experience produced by the technological ecosystem, the consumer driving the experience and the matching of ads to individuals. The consumer is guided through an experience that takes a social/psychological journey to ascertain areas of interest to them from the perspectives and ranking of needs, wants, desires and wishes as defined by the consumer. Then the consumer enjoys and is informed by advertisements across some or all of their personal and social digital devices and networks. The consumer's profile is secured, in sync with other devices and digital content and communications. Digital advertisements include, but are not limited to, web advertising, TV advertising, mobile advertising, tablets and other electronic advertising platforms.

FIG. 7 depicts an exemplar graphical user interface of a user dashboard of needs, wants, wishes and desires 700 following the preference process described in connection with FIGS. 4 and 4a. An example category box 701 is for “needs,” and includes an image for an insurance service sought by the user. From this screen, the user may navigate back to the preference selection screen as described by reference to FIGS. 4 and 4A.

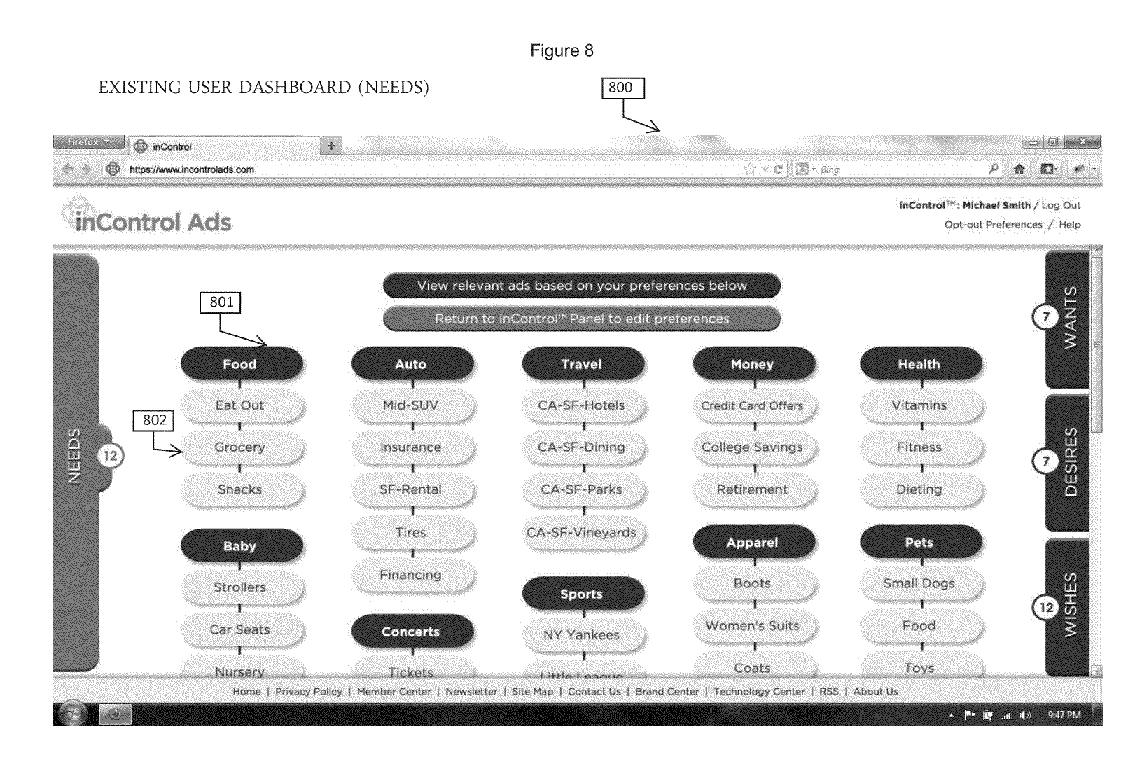

FIG. 8 is an exemplar graphical user interface 800 depicting the categories and subcategories of a user's defined “needs. ” The user could then click on a category button 801 and further edit sub-categories of needs such as “grocery” 802.

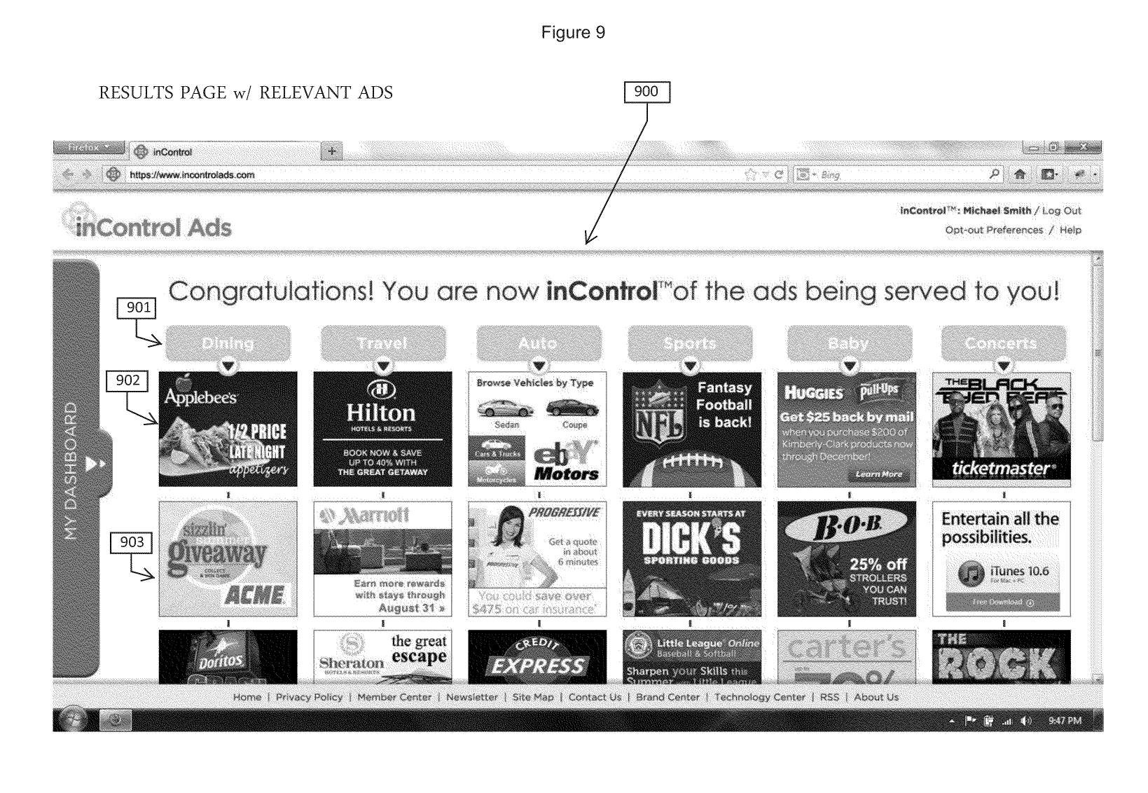

FIG. 9 is an exemplar graphical user interface 900 depicting the user's categories of interest, such as “Dining,” 901 and exemplar advertisements 902, 903 generated by such user choices. In this way, a user can receive visual feedback and information on any match or mismatch between personal preferences and advertisements and make corrections as necessary.

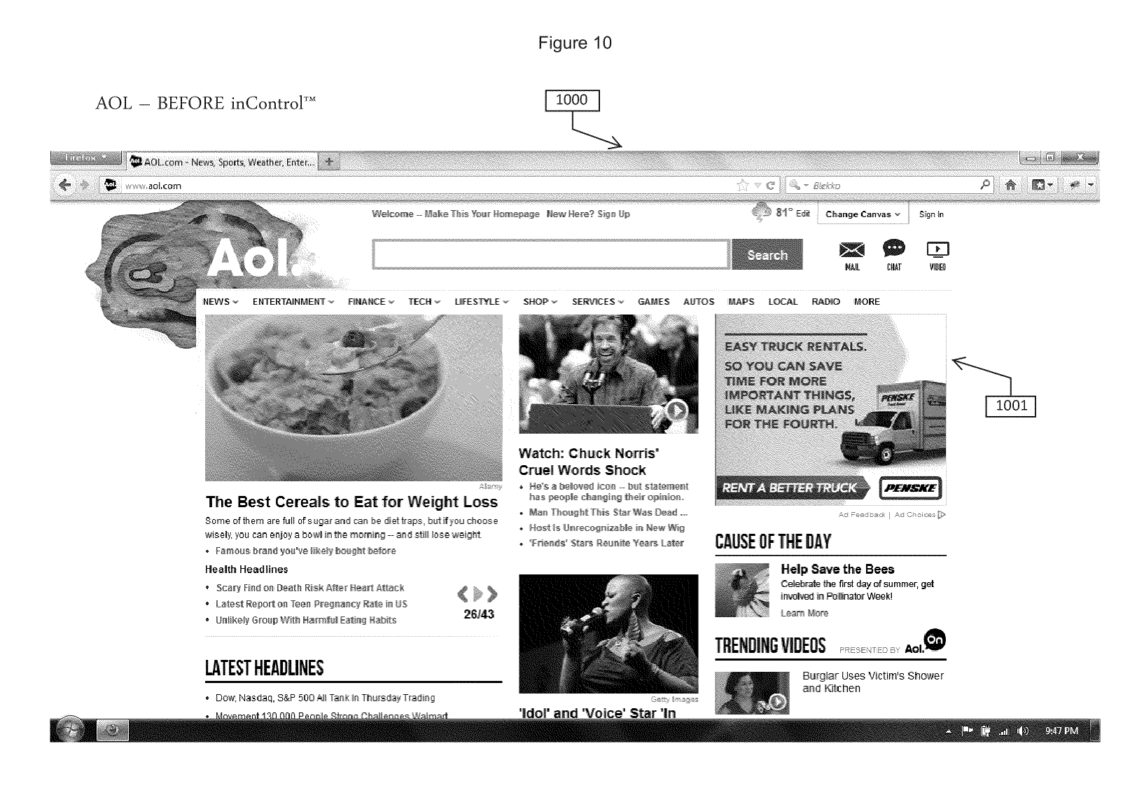

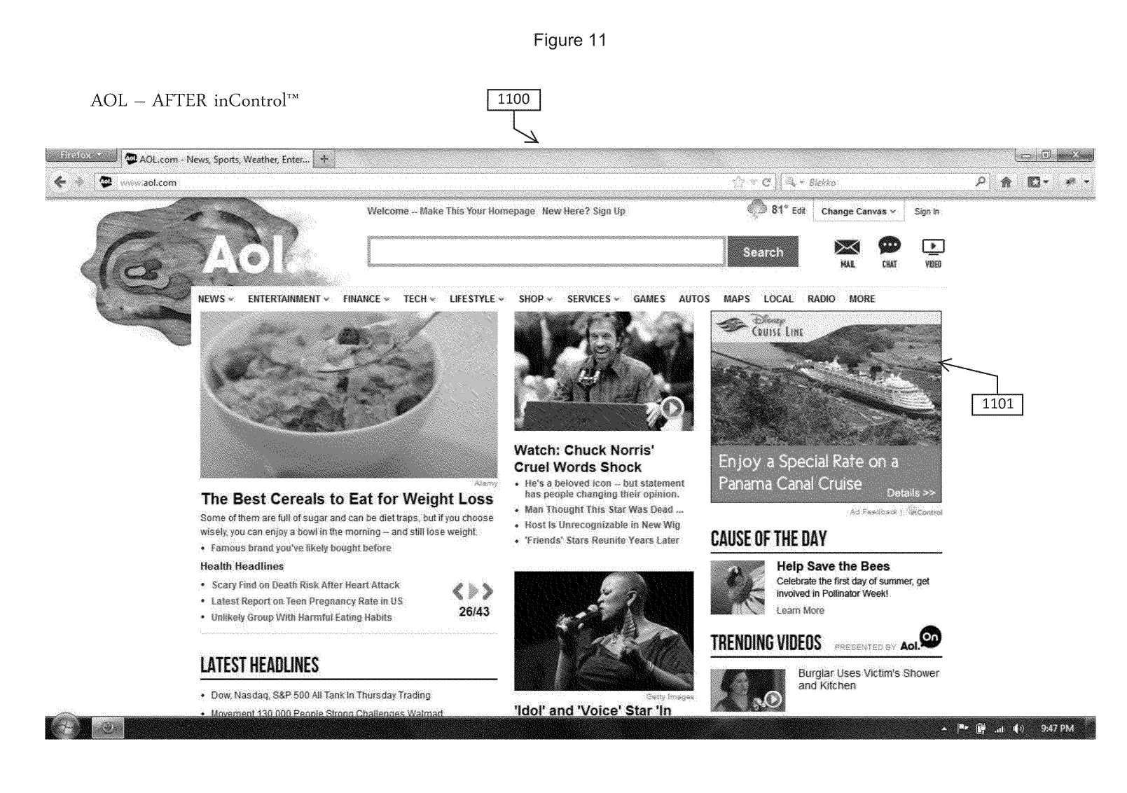

FIGS. 10 depicts an exemplar graphical user interface 1000 of a web service, such as AOL, in which an advertisement 1001 is presented to a user. In this case, FIG. 10 depicts an advertisement 1001 for a truck rental service, which a particular user may or may not be interested in. FIG. 11 shows the identical generated page 1100 but with a depicting a cruise ship offering 1101, which, in this example, reflects a user's preferred interest in travel advertisements. Use of the systems described herein allows for the presentation of such preferred advertisements.

The disclosed system involves technology that uses a computing system. The system includes at least one computing device. In some embodiments the computing system further includes a communication network and one or more additional computing devices (such as a server).

The computing device can be, for example, located in the office of an advertiser or publisher or any other place of business or can be a computing device located in a consumer's or user's home. The computing device can be a stand-alone computing device or a networked computing device that communicates with one or more other computing devices across a network. The additional computing device(s) can be, for example, located remotely from the first computing device, but configured for data communication with the first computing device across a network.

In some examples, the computing devices include at least one processor or processing unit and system memory. Depending on the exact configuration and type of computing device, the system memory may be volatile (such as RAM), non-volatile (such as ROM, flash memory, etc.) or some combination of the two. System memory typically includes an operating system suitable for controlling the operation of the computing device, such as the WINDOWS® operating systems from Microsoft Corporation of Redmond, Wash. or a server, such as Windows SharePoint Server, also from Microsoft Corporation. The system memory may also include one or more software applications and may include program data.

The computing device may have additional features or functionality. For example, the device may also include additional data storage devices (removable and/or non-removable) such as, for example, magnetic disks, optical disks, or tape. Computer storage media may include volatile and nonvolatile, removable and non-removable media implemented in any method or technology for storage of information, such as computer readable instructions, data structures, program modules, or other data. System memory, removable storage, and non-removable storage are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by the computing device. An example of computer storage media is non-transitory media.

In some examples, one or more of the computing devices can be located in an establishment, such as an office or place of business. In other examples, the computing device can be a personal computing device that is networked to allow the user to access the system disclosed herein from a remote location, such as in a user's home or other location. In some embodiments, the computing device is a smart phone or other mobile device. In some embodiments the application is stored as data instructions for a smart phone application. A network facilitates communication between the computing device and one or more servers, such as an additional computing device, that host the application. The network may be a wide variety of different types of electronic communication networks. For example, the network may be a wide-area network, such as the Internet, a local-area network, a metropolitan-area network, or another type of electronic communication network. The network may include wired and/or wireless data links. A variety of communications protocols may be used in the network including, but not limited to, Ethernet, Transport Control Protocol (TCP), Internet Protocol (IP), Hypertext Transfer Protocol (HTTP), SOAP, remote procedure call protocols, and/or other types of communications protocols.

In some examples, the additional computing device is a Web server. In this example, the first computing device includes a Web browser that communicates with the Web server to request and retrieve data. The data is then displayed to the user, such as by using a Web browser software application. In some embodiments, the various operations, methods, and rules disclosed herein are implemented by instructions stored in memory. When the instructions are executed by the processor of one or more of the computing devices, the instructions cause the processor to perform one or more of the operations or methods disclosed herein. Examples of operations include submitting and modifying User Preferences and identifying Advertisements to be published, among other operations and functions.

What is claimed is:

1. A method of controlling the display of advertisements comprising:
utilizing a networked computing device having a processing device and a memory device, the memory device storing information that, when executed by the processing device, causes the processing device to:
provide a graphical interface for a user to create and manage a personal profile, wherein the personal profile is enabled to receive information from the user about the user's purchase behaviors, the user's interest in categories of products and services and the user's brands of interest; and
store the personal profile information in a networked database.

2. The method of claim 1, wherein the networked database is enabled to compare the personal profile information with information associated with advertisements.

3. The method of claim 2, wherein the networked database is enabled to select certain advertisements to display to the user in the graphical interface based on the personal profile information.
